(19) United States
(12) Patent Application Publication
(10) Pub. No.: US 2021/0042822 A1
(43) Pub. Date: Feb. 11, 2021

(54) AUTOMATED CREDIT MODEL COMPLIANCE PROOFING

(71) Applicant: LendingClub Corporation, San Francisco, CA (US)

(72) Inventors: Jianju Liu, Kentfield, CA (US); Jianglan Han, San Francisco, CA (US); Xirui Wang, Foster City, CA (US)

(21) Appl. No.: 16/532,009

(22) Filed: Aug. 5, 2019

(51) Int. Cl. G06Q 40/02; G06N 5/02

(52) U.S. Cl. CPC G06Q 40/025; G06N 5/025

(57) ABSTRACT

Techniques are provided for testing policy modules for bias. Policy modules are software modules that generate lending decisions based on information about loan applicants. The techniques involve performing multiple testing iterations based on each test case. For example, in one iteration, values for all input parameters of the policy module may come from the test case. That iteration produces a “baseline” lending decision. During other iterations, the values for most input parameters do not change. However, for the one or more input parameters that correspond to the characteristic for which bias is being tested, the input values are changed from iteration to iteration. For example, when checking for age bias, the age of a loan applicant may be varied with each iteration. The lending decisions generated based on each test case are collectively referred to as a “sibling batch” of lending decisions. The testing platform determines whether bias exists based, at least in part, on the degree of deviation among the lending decisions in each sibling batch.

### FIELD OF THE INVENTION

The present invention relates to automated software testing platforms and, more specifically, to an automated testing platform for performing credit model compliance proofing.

### BACKGROUND

Institutions that lend money typically have developed proprietary software modules, referred to herein as “policy modules” for generating lending decisions for loan applicants based on information about the loan applicants. Referring to FIG. 1, it illustrates a policy module 100.

The pieces of information that a policy model takes as input are referred to herein as “policy input parameters” (102). The policy input parameters may vary from policy module to policy module. For example, one policy module may have a policy input parameter for receiving the phone number of a loan applicant, while another policy module does not. Further, even when policy input parameters have the same meaning (e.g. last name), different policy models may have different labels for those policy input parameters. For example, the policy module of one institution may have a “lastname” input parameter, while the policy module of another institution may have a “surname” input parameter. In this example, both policy modules expect the same information (the last name of the loan applicant), but have different labels associated with the input parameter used to input that information.

Internally, policy module 100 may have a credit model 106 and a strategy module 114. The credit model 106 generates a loan score 112 based on information about a loan applicant. In one embodiment, the loan score 112 is an estimation of the likelihood that the applicant in question would default on a loan. The information that a credit model takes as input is referred to herein as “model input parameters” (110). The model input parameters 110 may include some or all of the policy input parameters 110.

The loan score 112 produced by the credit model 106 is fed into the strategy module 114. In addition to the loan score 112, the strategy module 114 may take additional input parameters, including some or all of the policy input parameters 102. Based on the loan score 112 and these additional input parameters, the strategy module 114 generates the lending decision 104 that is output by the policy module 100.

While FIG. 1 illustrates how one embodiment of a policy module may be internally implemented, the actual internal implementation of policy modules may vary from institution to institution. To parties other than the institution to which a policy module belongs, each policy module is merely a “black box”, where the input parameters and the output parameters are known, but the internal logic and implementation is hidden.

It is critical that policy modules comply with laws and regulations that govern lending policies. For example, policy modules cannot produce lending decisions that discriminate against loan applicants based on characteristics such as race, religion, gender or age. Statistics that cannot be used as a basis for discrimination are referred to herein as “prohibited characteristics”. Further, policy modules cannot produce lending decisions that discriminate against loan applicants based on “surrogate characteristics”. A surrogate characteristic is a characteristic that may have a high correlation with a prohibited characteristic. For example, “years working” may have a high correlation with “age”, and “zip code” may have a high correlation with “race”.

Often, the logic implemented within policy modules is so complex that it is not easy to determine, by inspecting the logic itself, whether the lending decisions produced by the policy module violate the laws and regulations that govern lending policies. For example, it may not be apparent, from the logic alone, that the lending decisions produced by a particular policy module are sensitive to the zip code of an applicant, and therefore may violate the prohibition of using a surrogate of the “race” characteristic.

Based on the foregoing, it is clearly desirable to provide a software testing platform to test policy modules to verify that they will not violate the relevant laws and regulations before such policy modules are actually used to make lending decisions. By performing compliance proofing prior to real-world use of a policy module, it is possible for policy module developers to fix any logic that would result in non-compliant lending decisions before such non-compliance occurs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of a policy module used to make lending decisions;

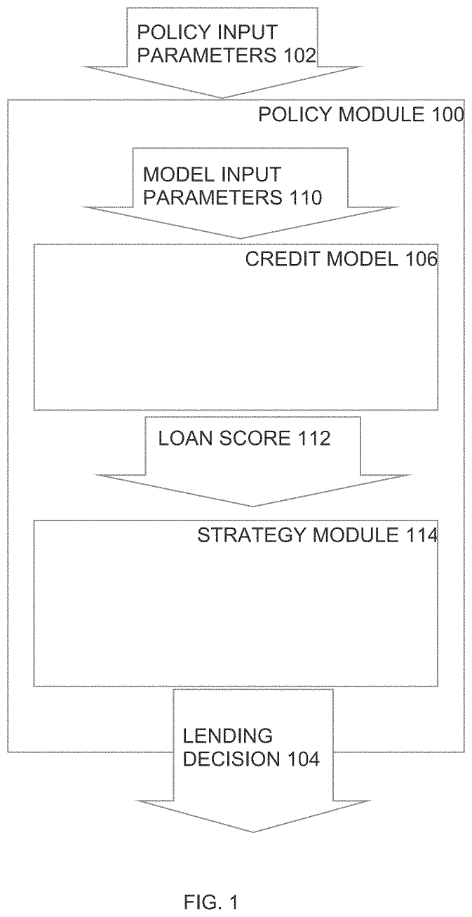

FIG. 2 is a block diagram of a user interface generated by a mapping creation tool to specify the fields of test data that correspond to input parameters of a policy module, according to one embodiment;

FIG. 3 is a block diagram of a user interface generated by the mapping creation tool to specify the mapping between fields used by test data and input parameters of a policy module, according to an embodiment;

FIG. 4 is a flowchart illustrating steps for iteratively testing a policy module for compliance, according to an embodiment;

FIG. 5A is a chart that may be generated by the testing platform to display the APRs produced by varying the ages for a particular test case, according to an embodiment;

FIG. 5B is a chart that may be generated by the testing platform to display the APRs produced by varying the ages for a particular test case, where the policy module exhibits an age bias;

FIG. 5C is a chart that may be generated by the testing platform to display the interest rates produced by varying the zipcodes for a particular test case, where the policy module exhibits a location bias;

FIG. 6 is a chart that may be generated by the testing platform to display the interest rates produced by varying the zipcodes for a particular test case, where deviation is caused by an exceptional rule that applies to a region that covers two of the zipcodes;

FIG. 7 is a block diagram of a policy module testing platform, according to an embodiment; and

FIG. 8 is a block diagram of a computer system upon which the policy module testing techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A software testing platform is provided to allow one party (the “testing party”) to test policy modules developed by other parties (the “policy module developers”). Significantly, policy modules are tested as black boxes, so that policy module developers need not disclose to the testing party any proprietary techniques or logic implemented in their policy modules. According to one embodiment, the testing platform uses real historical lending data as the starting point to determine whether policy modules comply with the laws and regulations that govern lending policies.

According to one embodiment, the testing platform reads information about a real-life loan applicant. The platform then maps pieces of that information to the corresponding policy input parameters of a policy module that is being tested. Based on the values of the policy input parameters, the policy module generates a baseline lending decision. This process is performed for multiple iterations. However, at each iteration, the value of one or more of the policy input parameters is changed. For example, assume that the policy input parameters for a particular policy module are firstname, lastname, age, and zip. During the first testing iteration, the values for the policy input parameters may be <Susan, Johnson, 31, 95051>. These first iteration values may in fact be real-world values from historical information about an actual loan applicant.

During subsequent iterations, the testing platform may vary one or more of the input values. For example, to test whether the policy module implements a policy that is sensitive to zipcode (which may be a surrogate for race), the testing platform may vary the zipcode values for subsequent iterations, as follows:

<Susan, Johnson, 31, 95051>
<Susan, Johnson, 31, 95052>
<Susan, Johnson, 31, 95055>
<Susan, Johnson, 31, 95070>

The lending decisions produced by the policy module during the iterations for a given test case are referred to herein as a “sibling batch” of lending decisions. After generating a sibling batch of lending decisions, the values contained in those lending decisions (e.g. APR, interest rate, terms, etc.) are compared to each other. If the values contained in the lending decisions do not match, and the only input parameter changed during the testing iterations was the zipcode value, then the policy module may be flagged as non-compliant. The testing platform may generate an alert that identifies the potential problem. For example, the testing platform may generate an alert that states “Potential non-compliance: lending decision varies with zipcode which may be a surrogate for race”.

### Creating a Test-Data-to-Input-Parameter Mapping

As mentioned above, the policy input parameters used by the policy modules may vary from policy module to policy module. For example, for one policy module, a policy input parameter may be telephone number, while another policy module may not use telephone number as a policy input parameter. Because the policy input parameters may vary, and the labels used by the input parameters may vary from the labels used for the corresponding pieces of test data, a mechanism is provided for creating test-data-to-input-parameter mappings.

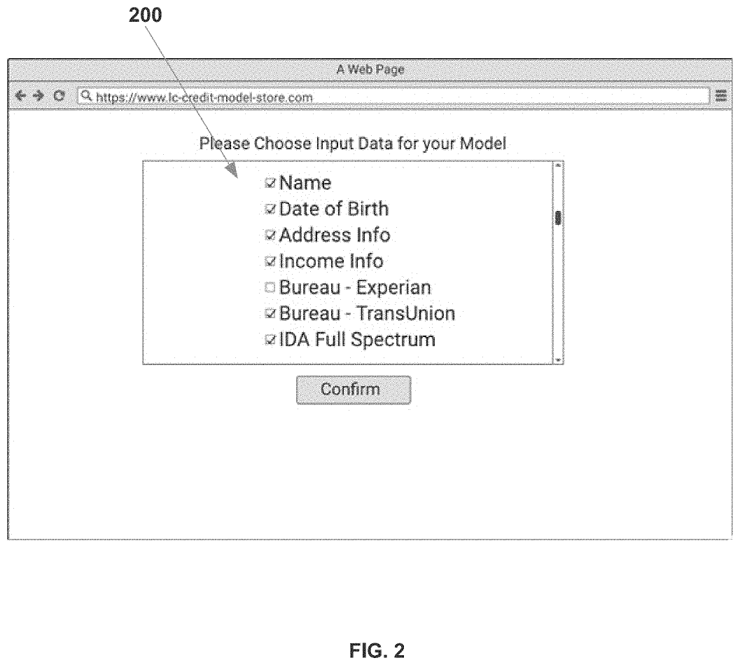

Referring to FIG. 2, it is a block diagram of a user interface generated by a mapping creation tool. The user interface illustrated in FIG. 2 allows a user to specify the fields of data, from a repository of historical lending information, that are to be used as input to a policy module that is to be tested. In the illustrated embodiment, a field-list 200 is displayed. The field-list 200 includes labels for the various types of information contained in the repository of historical lending information. Next to each label is a checkbox. The user that is creating the test-data-to-input-parameter mapping checks the checkbox next to each field that corresponds to an input parameter of the policy module that is being tested. Once all of the appropriate labels have been selected, the user selects a “confirm” button.

Significantly, the labels in the field-list may not be the same labels that are used for the policy input parameters of the policy module that is to be tested. Therefore, according to one embodiment, after the test data labels have been selected, an interface is provided to allow the user to specify the mapping between the test data labels and the labels of the corresponding policy input parameters.

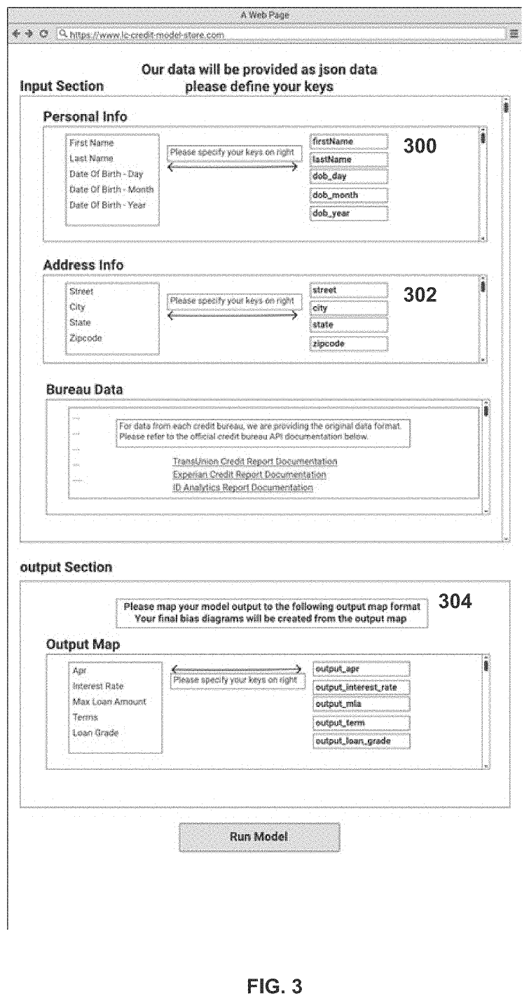

Referring to FIG. 3, it illustrates a user interface generated by the mapping creation tool to allow users to map test data labels to the labels of the corresponding policy input parameters of a policy module to be tested. In the illustrated embodiment, a region 300 is provided for establishing the mappings between (a) the fields in the “Personal Info” category from test data labels, and (b) policy input parameter labels. Similarly, a region 302 is provided for establishing the mappings between (a) the fields in the “Address Info” category from test data labels, and (b) policy input parameter labels.

The mapping creation tool that provides the interfaces illustrated in FIGS. 2 and 3 generates output that records the mappings specified by the tool's user. The test-label-to-input-label mapping for a given policy module is referred to herein as the “data dictionary” for the policy module. An example data dictionary may include the following mappings:

| Test Data | Policy Module |
|---|---|
| Fields | Input Fields |
| First Name | firstName |
| Last Name | lastName |
| Date Of Birth | DOB |

The interface illustrated in FIG. 3 also allows users to map (a) the labels associated with the lending decision that is output by the policy module to (b) output labels used by the testing platform. In the illustrated example, the output labels used by the policy module (output_apr, output_interest_rate, output_mla, output_term, and output_loan_grade) are mapped to the output labels (Apr, Interest Rate, Max Loan Amount, Terms, Loan Grade) used by the testing platform.

The interfaces illustrated in FIGS. 2 and 3 are merely examples of interfaces that may be used to specify mappings between the fields available in the test data and the fields used as input to a policy module that is to be tested. The techniques described herein are not limited to any particular user interfaces, nor any set of test data labels or input parameter labels.

### Input Transformation

In some situations, the difference between the test data fields and the policy module input fields may be more than a labeling difference. For example, assume that “DOB” is one of the policy module input fields, but the test data does not include date of birth values. Under these circumstances, it may be possible to derive values for the input parameters based on values from other fields within the test data. For example, if the test data has an age field, then date of birth values may be approximated by subtracting the age value from the current date.

In the case where the test data is from prior loan applications, the age information contained in the test data was current as of the date of the loan application. Thus, in one embodiment, rather than subtract the age value from the current date, the testing system may subtract the age value from the loan application date in order to derive an approximate date of birth. Age and date of birth is merely one example of fields that are sufficiently logically related that one may be approximately derived from the other. For any such set of logically related fields, the testing platform can perform on-the-fly transformations on the test data to derive the values needed for the input parameters of any given policy module.

### Iterative Testing for Compliance

Once the data dictionary for a particular policy module has been generated, the policy module may be tested iteratively for compliance with the applicable lending laws and regulations. Such testing includes testing to determine whether the logic in the policy module exhibits any prohibited bias. A prohibited bias may be, for example, adjusting the lending decision based on the race, gender, age or religion of the loan applicant.

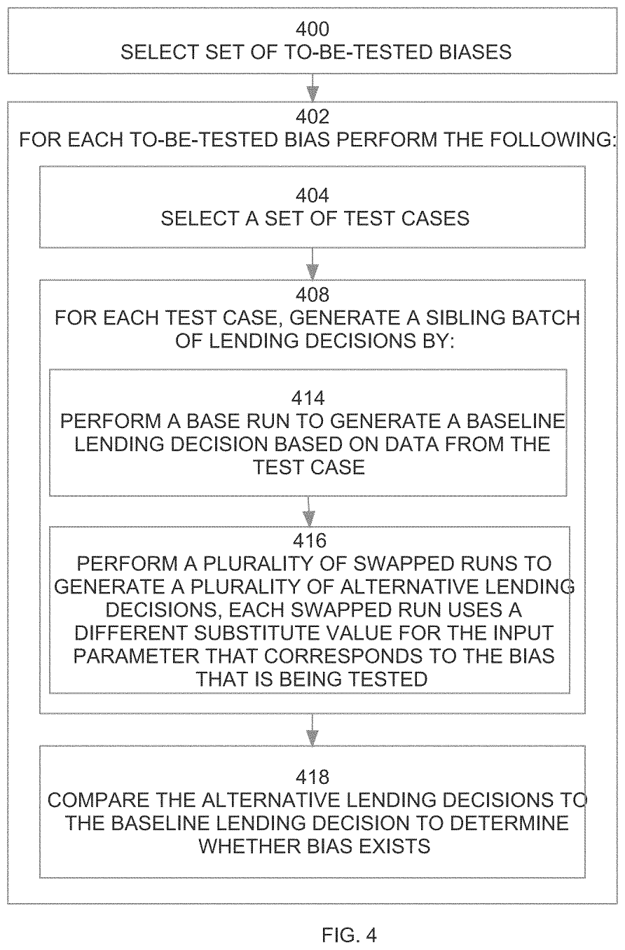

Referring to FIG. 4 it is a flowchart that illustrates how the testing platform performs bias testing, according to an embodiment. At step 400, the testing platform selects a set of to-be-tested biases. The set of to-be-tested biases may include, for example, race, gender, age and religion. In some circumstances, the set of to-be-tested biases may be different. For example, if the policy module being tested does not have any input parameters that correspond to religion or any surrogate of religion, then religion may not be in the set of to-be-tested biases.

Box 402 includes steps that are performed for each of the to-be-tested biases. For the purpose of explanation, it shall be assumed that the first characteristic for which bias is tested is “race”, and the policy module does not have an input parameter that directly indicates race. Under these circumstances, the “zipcode” input parameter may be used as a surrogate for “race” because in some areas there is a strong correlation between race and zipcode.

At step 404, a set of test cases are selected for testing the characteristic in question. As shall be described in greater detail below, each of the test cases may correspond to real-world data about a previously-made loan. For example, the test cases may be in the form of:

<Loan number: 123456, Firstname: Susan, Lastname: Johnson, age:
31, ...>
<Loan number: 173651, Firstname: Bob, Lastname: Jones, age: 63, ...>

Box 408 includes steps that are performed for each of the test cases that were selected in step 404. Specifically, at step 414, a “base run” is performed to generate a baseline lending decision by feeding data from the current test case into the policy module that is being tested. Based on the data from the current test case, the policy module generates a lending decision. The lending decision that is generated based on the unaltered test case data is referred to herein as the “baseline lending decision”.

For example, assume that the first test case selected to test for racial bias is from a loan record that has the following values: <Loan #: 123456, Firstname: Susan, Lastname: Johnson, age: 31, zip: 95051 . . . >

Assume further that the policy module being tested has input parameters for firstname, lastname, age, zip, etc. Under these assumptions, the input values fed to the policy module during the base run to generate the baseline lending decision in step 414 would be: <Susan, Johnson, 31, 95051 . . . >

At step 416, a plurality “swapped runs” are performed to generate a plurality of alternative lending decisions. During each of the swapped runs, the input data is a slightly modified version of data from the test case. Specifically, during step 416, the testing platform feeds the same input data (from the test case) into the same input parameters of the policy module, with the exception of the input parameter that corresponds to the characteristic that is being tested for bias. The value fed to the input parameter that corresponds to the characteristic that is being tested for bias is changed by the testing platform during each testing iteration.

For example, if racial bias is being tested, and zipcode is a surrogate for race, then during step 416 the swapped runs may use the input values:

<Susan, Johnson, 31, 95052...>
<Susan, Johnson, 31, 95055...>
<Susan, Johnson, 31, 95070...>

Feeding these input values into the policy module will produce a set of alternative lending decisions for the test case. At step 418, the alternative lending decisions are compared to the baseline lending decision. If all of the alternative lending decisions are identical to the baseline lending decision, then the results for that test case do not reveal any impermissible bias.

### Testing Example

For the purposes of explanation, assume that a policy module has input parameters for firstname, lastname, age, date of birth, and zipcode. Assume further that the first characteristic for which compliance is to be tested is age, and that the first selected test case has the values <Susan, Johnson, 31, 1/1/2000, 95135>.

Under these conditions, input values for “age” and “date of birth” (which is a surrogate for age) are changed during each testing iteration, while the values for remaining characteristics (firstname, lastname, and zipcode) remain constant. For example, the values fed to the policy module during the N iterations for the first test case may be:

iteration 1: <Susan, Johnson, 31, 1/1/2000, 95135>
(generates the baseline lending decision)
iteration 2: <Susan, Johnson, 20, 1/1/1999, 95135>
iteration 3: <Susan, Johnson, 21, 1/1/1998, 95135>
iteration 4: <Susan, Johnson, 22, 1/1/1997, 95135>
* * *
iteration N: <Susan, Johnson, 55, 1/1/1964, 95135>

During each of the iterations, the policy module outputs lending decisions based on the input values from the test case. The baseline lending decision (generated in step 414) and the alternative lending decisions (generated in step 416) collectively comprise a “sibling batch” of lending decisions. Any deviation among the lending terms in the sibling batch may be an indication of impermissible bias. For example, when all other input parameter values remain equal, if changing the age of a loan applicant changes any of the terms in the lending decision, the policy module may exhibit an impermissible age bias.

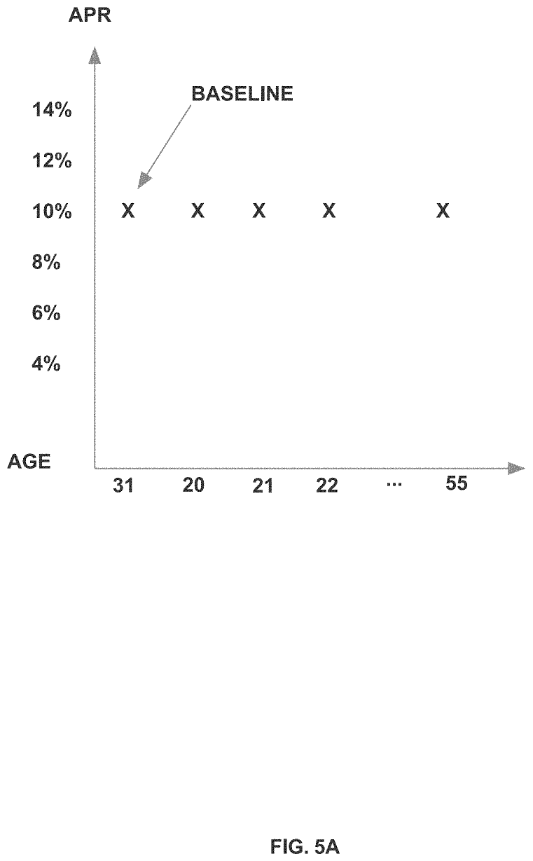

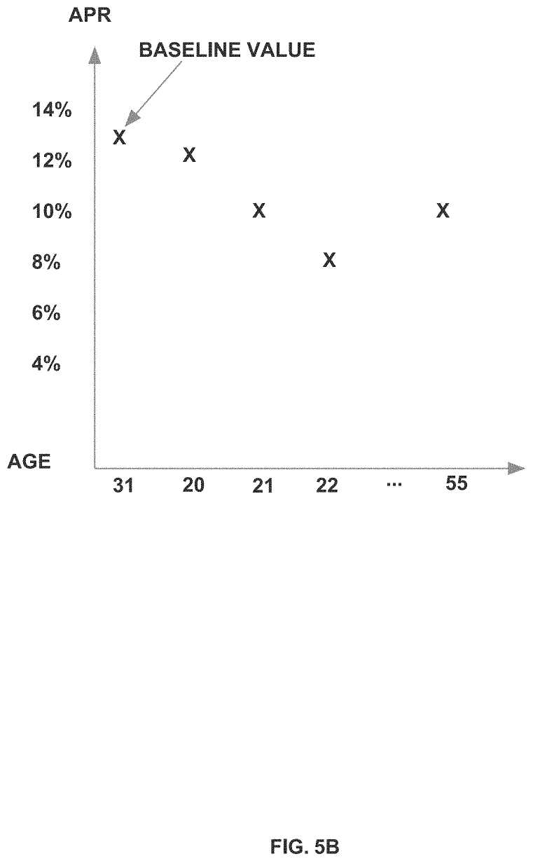

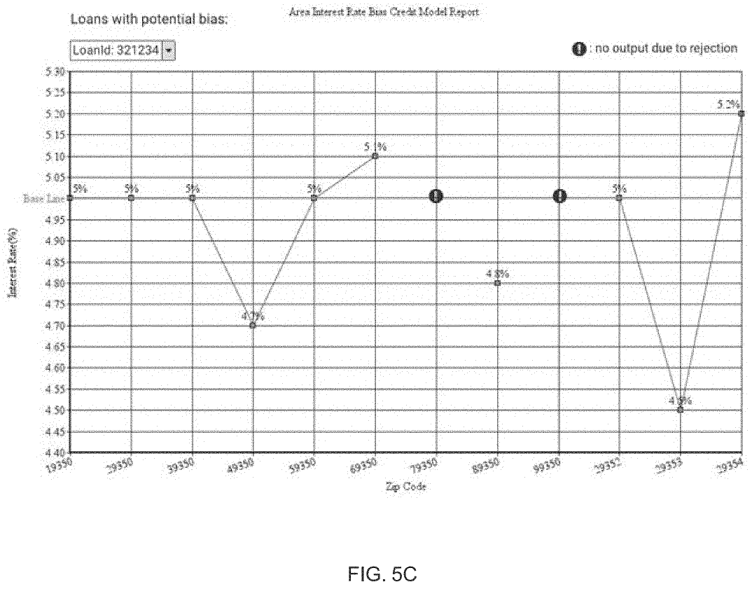

According to one embodiment, the lending platform may generate charts to depict how each characteristic affects each lending decision parameter. For example, assume the lending decision parameters that are output by the policy module include APR, Interest Rate, Max Loan Amount, Terms, and Loan Grade. A chart that may be generated to show the effect of age on APR is illustrated in FIG. 5A.

Referring to FIG. 5A, it is a chart that illustrates the APR value that was output during each of the N testing iterations performed for the age characteristic based on the first test case. As illustrated in FIG. 5A, the APR remained constant (10%) during all iterations. The fact that APR did not vary when the value of the input age characteristic was varied is an indication that the policy module is not biased relative to the age characteristic, at least with respect to APR. Similar charts can be generated for the other output parameters of the policy module, such as Interest Rate, Max Loan Amount, Terms, and Loan Grade. If any one of these output parameters varies in response to a variation of the loan applicant's age, then the policy module may have an age bias that violates the relevant lending regulations.

In contrast to the chart illustrated in FIG. 5A, FIG. 5B depicts a chart in which the APR that is output by the policy module for a given test case varies significantly in response to variations in age. Such variation is likely to be in violation of the relevant lending regulations. Consequently, the testing platform may generate an alert to indicate the potential violation.

As mentioned above, the testing may be repeated using multiple test cases. Once testing has been completed for all test cases for one of the prohibited characteristics (e.g. age), the testing platform repeats the testing process for the rest of the prohibited characteristics and/or their surrogates. That is, the steps contained in box 402 are repeated for each of the to-be-tested biases.

For example, after determining that, for all test cases, none of the output parameters varied based on the age of the loan applicant, the testing platform may perform another series of tests to ensure that the output parameters (lending decisions) do not vary based on the zipcode of the loan applicants. For each test case, the zipcode changes during each iteration while the remaining input values stay constant. For example, the input parameters for the N iterations of the zipcode testing may be:

iteration 1: <Susan, Johnson, 31, 1/1/2000, 95135>
(generates the baseline lending decision)
iteration 2: <Susan, Johnson, 31, 1/1/2000, 95137>
iteration 3: <Susan, Johnson, 31, 1/1/2000, 95140>
iteration 4: <Susan, Johnson, 31, 1/1/2000, 95149>
* * *
iteration N: <Susan, Johnson, 31, 1/1/2000, 95080>

After performing the testing iterations for zipcode, the testing platform may generate charts for each of the output parameters similar to the charts illustrated in FIGS. 5A and 5B. Similar to the age testing case, the testing platform may generate an alert if the output values in the sibling batch for any test case are sensitive to the zipcode of the loan applicant.

FIG. 5C is a chart that displays how changing the zip code for particular test case (LoanID: 321234) affects the Interest Rate values of the lending decisions of a sibling batch. As illustrated in FIG. 5C, the Interest Rate varied significantly from the baseline (5%) for several zipcode values. Unless those non-matching interest rate data points correspond to exceptional rules (e.g. areas in which regulations impose a cap and/or floor on interest rates), the variation in lending decisions within the sibling group may indicate an impermissible racial bias.

### Real-World Input Data

According to one embodiment, each test case involves information about a real-world loan applicant. For example, the first iteration of both the age testing and the zipcode testing used the input values <Susan, Johnson, 31, 1/1/2000, 95135>. These input values may be the actual data from a real-world loan applicant. As explained above, subsequent iterations for the same test case continue to use the real-world data for input, with the exception of the values that corresponded to the characteristic for which compliance is being tested.

However, the policy module testing techniques described herein do not require the use of real-world data. For example, in alternative embodiments, even the first iteration of testing may use values from fabricated test cases.

### Testing Across Multiple Loan Applicants

In the example given above, the “age” characteristic is tested by performing multiple test iterations using information from a single test case (loan applicant Susan Johnson). The lending decisions generated from a single test case constitute a sibling batch. The output values in each sibling batch may be compared against each other to determine whether bias exists. Unfortunately, the fact that there is no variation in the output values of the sibling batch produced by a single test case is often insufficient to conclude that no bias exists.

Therefore, according to one embodiment, the testing platform is configured to test each characteristic (e.g. age) using multiple test cases, each of which produces its own sibling batch of lending decisions. For example, after testing for age sensitivity using Susan Johnson's input data, the testing platform may test for age sensitivity using Bob Jones' input data. The input data for Bob Jones may be significantly different than that of Susan Johnson, so different portions of the policy logic may be invoked. The N testing iterations using the Bob Jones input data may involve feeding the following input to the policy module that is being tested:

iteration 1: <Bob, Jones, 63, 5/5/1952, 40413>
iteration 2: <Bob, Jones, 20, 5/5/1999, 40413>
iteration 3: <Bob, Jones, 21, 5/5/1998, 40413>
iteration 4: <Bob, Jones, 25, 5/5/1997, 40413>
* * *
iteration 5: <Bob, Jones, 40, 5/5/1969, 40413>

It may be useful to test each characteristic with multiple loan applicants (test cases) to ensure that the policy module in question is not sensitive to the prohibited characteristic, even when the values of the other input parameters change. Thus, selecting a set of test cases to test for a given bias (step 404 in FIG. 4) may involve selecting a large number of test cases, with varying values (ages, genders, zipcodes) to decrease the chances that there is a combination of characteristics for which the policy module exhibits a prohibited bias.

### Testing Across Multiple Geographic Regions

Not only can the same policy module be tested across multiple loan applicants, as described above, but the loan applications may be selected to cover ever-expanding geographic regions. For example, a policy module may be tested based on data from each of 50 loan applicants selected from Northern California. Then the same policy module may be tested based on data from each of 50 loan applicants from Southern California. Then the same policy module may be tested based on data from 50 loan applicants from each of several randomly-selected states.

When selecting the 50 applicants from any given region, the testing platform may select loan applicants in a way to ensure a wide range of input values. For example, the testing platform may select loan applicants in a manner to cover a wide range of ages, a wide range of races, both genders, and a wide range of income levels.

In addition to selecting a wide range of loan applicants for the testing iterations, the values that are varied during the testing iterations may cover a wide range. For example, during the test for zipcode sensitivity, the set of zipcodes tested may fall within a particular region of the country, or may range across the entire country.

### Testing for Multiple Types of Bias

In the examples given above, tests are performed for zipcode bias (which may be a surrogate of race), and age bias. There is no limit to the number and types of bias for which a policy module may be tested. For example, a policy module may additionally be tested for gender bias, for religion bias, or for any other type of impermissible bias. The bias for which a policy module is being tested determines which input parameter has its value changed to generate the alternative lending decisions (step 416). For example, to test for gender bias, information from historical loan records may be fed to the policy module first indicating that the applicant is female, and then indicating that the same applicant is male. If that change affects the lending decisions, then gender bias exists.

### Surrogate Characteristics

As mentioned above, surrogate characteristics can also be tested. For example, assume that a policy module does not have an input that directly specifies the race of the applicant. In such situations, the name of the applicant can be changed during the testing iterations as a surrogate to race. For example, to generate the alternative lending decisions, the name of the test case applicant can be changed to names that have a strong correlation with race. For example, to generate the alternative lending decisions, the last name of the applicant can be changed to “Cheng”, “Rodriguez”, “Aherne”, “Borkowski”, etc.

If changing the name from “Johnson” to “Cheng” or “Rodriguez” results in a change in the lending decision, then the testing platform may conclude that the policy module has a racial bias.

If a policy module does not have an input parameter that corresponds to gender, testing for gender bias may also be performed using firstname as a surrogate. For example, after generating a baseline lending decision based on the actual name of a loan applicant, alternative lending decisions may be generated by changing the first name of the applicant to traditional female names (Mary, Tiffany, Susan), and then again to traditional male names (Fred, Joe, Michael). If changing the first name to a name that has a high correlation with gender results in a change to the lending decision, then the testing platform may conclude that the policy module has a gender bias.

### Detecting Non-Compliance

As mentioned above, at step 418 in FIG. 4, the testing platform compares the alternative lending decisions in a sibling batch to the baseline lending decision in a sibling batch to determine whether bias exists. According to one embodiment, a policy module does not automatically fail compliance testing when the lending decisions of a sibling batch show any sensitivity to a prohibited characteristic (or a surrogate thereof). Instead, some small degree of sensitivity may be allowed before the testing platform concludes that the policy module in question is non-compliant.

For example, assume that, for a particular test case, 99 tested zip code values produced the same APR, one tested zipcode resulted in an APR that was 0.1% off the baseline. Assume further that, for 100 other test cases, there was no deviation in the APR produced by changing the zipcodes. Given the low degree of sensitivity to changing zipcodes, the testing platform may determine that no zipcode bias exists (and therefore the policy module is compliant). On the other hand, if zipcode sensitivity was found in 50 of the 100 test cases, the testing platform may conclude that the policy module is non-compliant even though the deviation encountered in each test case was only 0.1%.

### Alerts

As mentioned above, the testing platform may generate alerts in response to detecting that the policy module being tested exhibits bias (i.e. is sensitive to a prohibited characteristic or a surrogate thereof). According to one embodiment, such alerts may include detailed information about the data that gave rise to the possible compliance violation. For example, assume that a particular policy module produced the APRs illustrated in FIG. 5B, which are clearly sensitive to the loan applicant's age. In addition to or instead of generating a chart, such as that shown in FIG. 5B, the testing platform may display the actual numbers that led to the disparate APR outcomes, and may indicate that degree to which the APR outcomes deviate from each other. For example, the testing platform may generate a “bias score” for each prohibited characteristic, where the bias score is 0 if the lending decisions are completely unaffected by variations in the characteristic, and greater the more the lending decisions are affected by variations in the characteristic.

### Avoiding False Positives

In some cases, even compliant policy modules can produce lending decisions that appear non-compliant. For example, different jurisdictions may place caps, floors, or both, on the APR for loans made in those jurisdictions. For example, assume that a particular region passed a law that the APR of loans cannot exceed 10%. In such situations, the lending decisions produced for a loan applicant in the particular region may differ from the lending decisions produced for the same loan applicant in other regions. Under normal circumstances, such deviation in lending decision outcomes would indicate non-compliance (because zipcode is a surrogate of race), and cause generation of an alert.

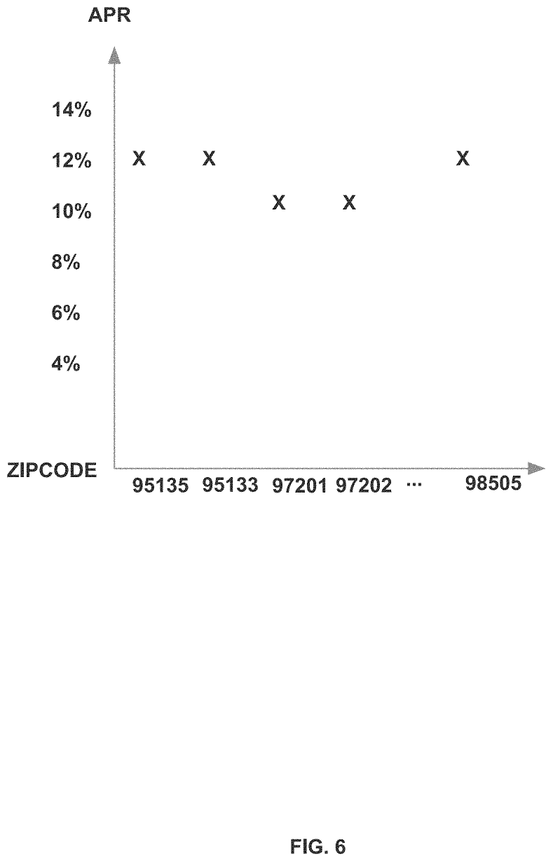

Referring to FIG. 6, it depicts a graph of the APRs from the lending decision results of a sibling batch. In this example, the policy module was fed identical input parameter values except for the zipcode of the loan applicant, which was changed from iteration to iteration. As illustrated in FIG. 6, the APRs produced by the policy module remained invariant (12%) across all zipcodes except for 97201 and 97202, for which a lower APR was generated (10%). Without any further knowledge, the fact that the APR changes based on zipcode would indicate non-compliance (the lending decisions are being based on applicant location, which can be a surrogate for race). However, the deviation in APR results may be due to regulations that apply to the region associated with zipcodes 97201 and 97202.

According to an embodiment, the testing platform has access to “exception information”. Exception information includes information about external factors that may cause deviations in the lending decision outcomes. Such external factors include, for example, externally-imposed constraints that affect lending decision outcomes, such as regional rules relating to caps and floors of interest rates. In the present example, the exception information may indicate that a region that includes zipcodes 97201 and 97202 has an APR cap of 10%.

The testing platform may make use of the exception information in a variety of ways. For example, in one embodiment, any values for which exceptions apply are skipped during the iterative testing. In the present example, because an exception applies to the APRs in a region that includes zipcodes 97201 and 97202, those zipcodes may be skipped when testing for zipcode-based deviations in the APRs of the lending decisions.

### Testing Exception Outcomes

Rather than skip the values for which exceptions apply, one embodiment intentionally tests all values to which exceptions apply. In such an embodiment, lending decisions produced for input values that are not associated with exceptions are treated as non-exception outcomes, and lending decisions produced for input values that are associated with exceptions are treated as exception outcomes. Thus, instead of producing one sibling group per test case, two sibling groups are created: a no-exception sibling group produced by the input values for which no exception applies, and an exception sibling group produced by the input values for which exceptions exist.

To determine whether a policy module is bias-compliant, the lending decisions in the no-exception sibling group are compared with each other to identify any impermissible deviation/bias. In addition to testing for bias-compliance, each lending decision in the exception sibling group is evaluated for compliance with the rules specified in their respective exceptions. Thus, the policy module that produced the results illustrated in FIG. 6 would be deemed compliant because:
there was no deviation in the non-exception outcomes (APRs are 12% for zipcodes that are not subject to special rules), and
the exceptional outcomes (for zipcodes 97201 and 97202) satisfy the applicable rule (APR cap of 10%) specified for the region that includes zipcodes 97201 and 97202.

It is possible for a policy module to be bias-compliant in that it exhibits no impermissible bias, and yet rule-non-compliant in that it violates rules specified in the exception information. For example, if the region that includes zipcodes 97201 and 97202 has the rule that APRs cannot exceed 9%, then the policy module would be bias-compliant (because there is no deviation in the APR of lending decisions that are not covered by exceptions) but not rule-compliant (because the APR of 10% for zipcodes 97201 and 97202 violates the rule that APRs cannot exceed 9% in those zipcodes).

### Evolving Policies

Lending policies tend to evolve on a frequent basis. With each evolution, the logic implemented in the policy module is updated to produce different lending decisions. With each such change, the policy module may be retested for compliance, since any change may introduce an impermissible bias.

### Generating Quality Scores for Policy Modules

In addition to testing for bias-compliance and rule-compliance, the policy module testing platform may be configured to generate a “quality score” for each policy module that is tested. Unlike bias testing, quality score generation does not involve comparing the lending outcomes in a sibling group against each other. Instead, the quality score for a policy model is generated based on a comparison between (a) the lending decisions made by the policy model that is being tested, and (b) the lending decisions made by a “gold standard” policy model, using the same input parameter values.

The gold standard policy model may be any policy model that is considered to be of high quality, either because it has proven itself over time or has successfully passed certain quality tests. The techniques described herein are not limited to any particular manner for selecting a gold standard policy model.

To generate a quality score for a policy model, data from the same test cases are fed to both the policy model that is being tested, and to the gold standard policy model. The lending decision outputs of the two models are compared, and a score is generated based on the degree to which the lending decisions of the tested policy model deviate from the lending decisions of the gold standard policy model.

### System Overview

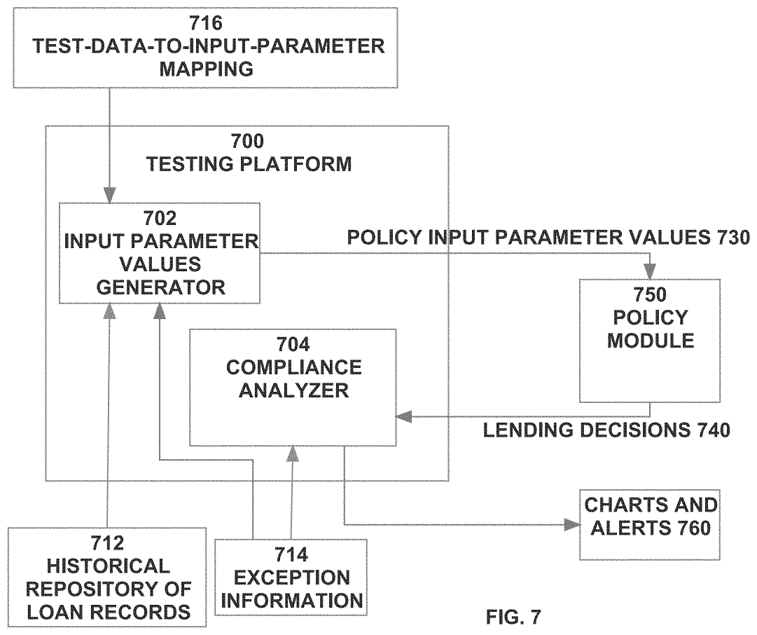

Referring to FIG. 7, it is a block diagram that depicts a policy module testing platform 700 according to an embodiment. Policy module testing platform 700 includes an input parameter values generator 702 and a compliance analyzer 704. Input parameter values generator 702 selects a loan record (test case) from a historical repository of loan records 712 to use as the basis for one round of testing. During a first iteration (step 414), the values from the selected loan record are fed to policy module 750 without modification to produce a baseline lending decision. Input parameter values generator 702 determines the mapping between the input parameters and the values of the test case based on the test-data-to-input-parameter mapping 716 that was generated for policy module 750. Based on the policy input parameter values 730, policy module outputs a lending decision 740.

After the first iteration, input parameter values generator 702 feeds the same input values into policy module 730 with the exception of the input parameter(s) for which sensitivity/bias is being tested (step 416). For example, to test for zipcode sensitivity, the input values of each iteration remain the same other than the input zipcode, which varies for each iteration. At the completion of step 416, a sibling group of lending decisions (740) will have been produced.

After the sibling group of lending decisions 740 has been generated, compliance analyzer 704 determines whether the lending decisions 740 of the sibling group vary based on zipcode (step 418). In determining whether impermissible zipcode bias exists, compliance analyzer 704 initially ignores the results for any “exceptional outcomes” (the outcomes for zipcodes for which special rules apply), which are identified based on the exception information 714.

If the lending decisions 740 include exceptional outcomes, those exceptional outcomes are compared against the applicable rules set forth in the exception information 714. If the lending decisions 740 do not reflect any impermissible bias and either (a) the lending decisions 740 do not include any exceptional outcomes, or (b) the exceptional outcomes comply with the corresponding rules, then the compliance analyzer 704 determines that policy module 750 is compliant. Otherwise, compliance analyzer 704 determines that policy module 750 is non-compliant.

In addition to determining whether policy module 750 is compliant, compliance analyzer 704 may generate alerts to report any noncompliance and/or display charts based on the lending decisions 740.

After performing compliance tests based on the information in one prior loan record, the same testing process may be repeated any number times based on information from additional prior loan records. As discussed above, the loan records for which testing of policy module 750 is performed may be selected in a manner that varies things such as age, location, race, income, etc. to ensure the test cases cover a wide gamut of loan applicants.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

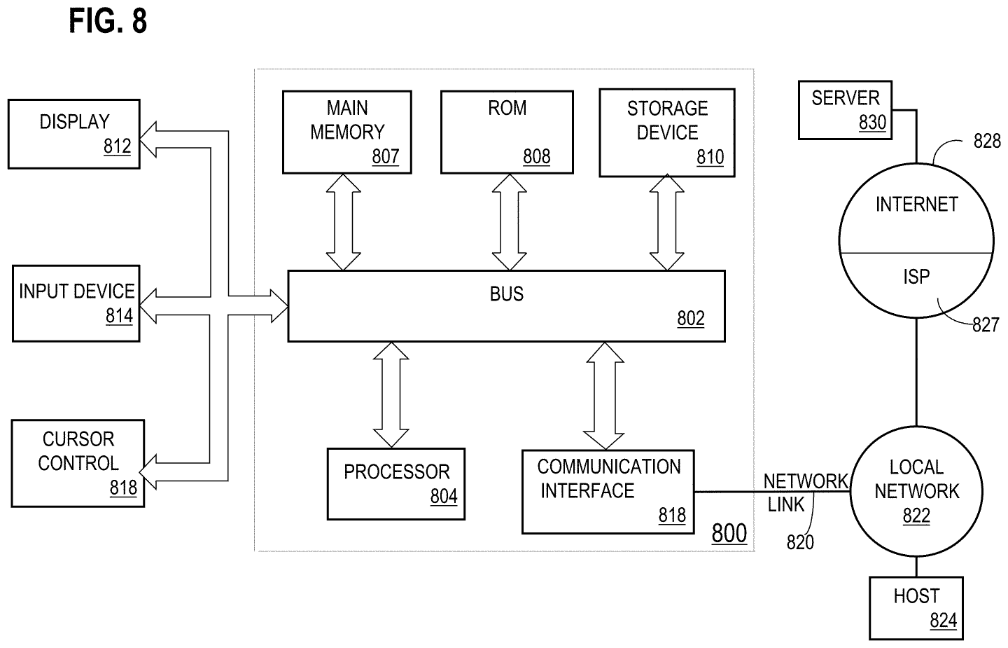

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for automatically testing whether a policy module exhibits a prohibited bias, comprising:
generating a mapping between a first set of labels that correspond to test data and a second set of labels that correspond to input parameters of the policy module;
wherein the input parameters of the policy module include:
a first set of one or more input parameters that do not correspond that a characteristic associated with the prohibited bias; and
a second set of one or more input parameters that do correspond to the characteristic associated with the prohibited bias;
performing a plurality of testing iterations, based on a single test case, to generate a sibling batch of lending decisions using the policy module;
wherein, during each testing iteration of the plurality of testing iterations, a distinct lending decision is generated by feeding values to the input parameters of policy module based on:
the mapping between the first set of labels and the second set of labels, and
values from the single test case;
wherein, during the plurality of testing iterations:
values for the first set of one or more input parameters remain constant; and
values for the second set of one or more input parameters are varied;
determining, based at least in part on the plurality of lending decisions in the sibling batch, whether the policy module exhibits the prohibited bias;
wherein the method is performed by one or more computing devices.

2. The method of claim 1 wherein the plurality of testing iterations includes:
one iteration in which a value from the single test case is fed to a particular input parameter, of the second set of one or more input parameters, to produce a baseline lending decision; and
multiple iterations in which substitute values that are not from the single test case are fed to the particular input parameter to produce a plurality of alternative lending decisions.

3. The method of claim 2 wherein determining whether the policy module exhibits the prohibited bias includes:
performing a comparison between the baseline lending decision and each of the plurality of alternative lending decisions;
based on the comparison, determining whether deviation from the baseline lending decision satisfies certain criteria; and
responsive to deviation from the baseline lending decision satisfying the certain criteria, determining that the policy module exhibits the prohibited bias.

4. The method of claim 1 wherein generating a mapping includes:
receiving user input that specifies a first set of fields, from a repository of test cases, from which to obtain values for test cases for the policy module; and
receiving user input that maps the first set of fields to a second set of fields, where the second set of fields are fields that correspond to input parameters of the policy module.

5. The method of claim 4 further comprising:
receiving user input that specifies that a transformation is to be performed on values from one of more fields in the first set of fields to derive values for a particular field in the second set of fields; and
performing the transformation on values from the one or more fields of the single test case to derive values for an input parameter of the policy module that corresponds to the particular field.

6. The method of claim 1 wherein:
testing whether the policy module exhibits a prohibited bias includes testing to determine whether the policy module exhibits a bias with respect to a prohibited characteristic; and
the prohibited characteristic is one of race, gender, age or religion.

7. The method of claim 6 wherein the prohibited characteristic is race, and the second set of one or more input parameters include a location-indicating input parameter that is used as a surrogate for race.

8. The method of claim 6 wherein the prohibited characteristic is race or gender, and the second set of one or more input parameters include a name parameter that is used as a surrogate for race or gender.

9. The method of claim 6 wherein the prohibited characteristic is age, and the second set of one or more input parameters include a date of birth parameter that is used as a surrogate for age.

10. The method of claim 1 further comprising:
selecting a plurality of test cases;
generating a sibling batch of lending decisions for each test case of the plurality of test cases; and
determining whether the policy module exhibits the prohibited bias based on deviation among lending decisions within each of sibling batch.

11. The method of claim 1 further comprising:
reading exception information that includes information about external factors that may cause deviations in lending decision outcomes;
based on the exception information, dividing lending decisions in the sibling batch into:
a first sibling batch that includes only non-exception outcomes; and
a second sibling batch that includes only exception outcomes;
determining whether the policy module exhibits the prohibited bias based on a degree of deviation among lending decisions in the first sibling batch; and
determining whether the policy module is rule compliant based on exception outcomes in the second sibling batch and corresponding rules in the exception information.

12. The method of claim 1 further comprising:
reading exception information that includes information about external factors that may cause deviations in lending decision outcomes; and
based on the exception information, selecting for the second set of one or more input parameters, only values to which external factors do not apply.

13. The method of claim 1 where the policy module is a first policy module and the sibling batch is a first sibling batch, the method further comprising:
performing a second plurality of testing iterations, based on the single test case, to generate a second sibling batch of lending decisions using a second policy module that is different from the first policy module;
performing a comparison between lending decisions in the first sibling batch and lending decisions in the second sibling batch; and
generating a quality score for the first policy module based, at least in part, on the comparison.

14. One or more non-transitory computer-readable media storing instructions which, when executed by one or more computing devices, cause:
generating a mapping between a first set of labels that correspond to test data and a second set of labels that correspond to input parameters of a policy module;
wherein the input parameters of the policy module include:
a first set of one or more input parameters that do not correspond that a characteristic associated with a prohibited bias; and
a second set of one or more input parameters that do correspond to the characteristic associated with the prohibited bias;
performing a plurality of testing iterations, based on a single test case, to generate a sibling batch of lending decisions using the policy module;
wherein, during each testing iteration of the plurality of testing iterations, a distinct lending decision is generated by feeding values to the input parameters of policy module based on:
the mapping between the first set of labels and the second set of labels, and
values from the single test case;
wherein, during the plurality of testing iterations:
values for the first set of one or more input parameters remain constant; and
values for the second set of one or more input parameters are varied; and
determining, based at least in part on the plurality of lending decisions in the sibling batch, whether the policy module exhibits the prohibited bias.

15. The one or more non-transitory computer-readable media of claim 14 wherein the plurality of testing iterations includes:
one iteration in which a value from the single test case is fed to a particular input parameter, of the second set of one or more input parameters, to produce a baseline lending decision; and
multiple iterations in which substitute values that are not from the single test case are fed to the particular input parameter to produce a plurality of alternative lending decisions.

16. The one or more non-transitory computer-readable media of claim 15 wherein determining whether the policy module exhibits the prohibited bias includes:
performing a comparison between the baseline lending decision and each of the plurality of alternative lending decisions;
based on the comparison, determining whether deviation from the baseline lending decision satisfies certain criteria; and
responsive to deviation from the baseline lending decision satisfying the certain criteria, determining that the policy module exhibits the prohibited bias.

17. The one or more non-transitory computer-readable media of claim 14 wherein generating the mapping includes:
receiving user input that specifies a first set of fields, from a repository of test cases, from which to obtain values for test cases for the policy module; and
receiving user input that maps the first set of fields to a second set of fields, where the second set of fields are fields that correspond to input parameters of the policy module.

18. The one or more non-transitory computer-readable media of claim 17 further storing instructions for:
receiving user input that specifies that a transformation is to be performed on values from one of more fields in the first set of fields to derive values for a particular field in the second set of fields; and
performing the transformation on values from the one or more fields of the single test case to derive values for an input parameter of the policy module that corresponds to the particular field.

19. The one or more non-transitory computer-readable media of claim 14 wherein:
testing whether the policy module exhibits a prohibited bias includes testing to determine whether the policy module exhibits a bias with respect to a prohibited characteristic; and
the prohibited characteristic is one of race, gender, age or religion.

20. The one or more non-transitory computer-readable media of claim 19 wherein the prohibited characteristic is race, and the second set of one or more input parameters includes a location-indicating input parameter that is used as a surrogate for race.

21. The one or more non-transitory computer-readable media of claim 19 wherein the prohibited characteristic is race or gender, and the second set of one or more input parameters includes a name parameter that is used as a surrogate for race or gender.

22. The one or more non-transitory computer-readable media of claim 19 wherein the prohibited characteristic is age, and the second set of one or more input parameters includes a date of birth parameter that is used as a surrogate for age.

23. The one or more non-transitory computer-readable media of claim 14 further comprising instructions for:
selecting a plurality of test cases;
generating a sibling batch of lending decisions for each test case of the plurality of test cases; and
determining whether the policy module exhibits the prohibited bias based on deviation among lending decisions within each of sibling batch.

24. The one or more non-transitory computer-readable media of claim 14 further comprising instructions for:
reading exception information that includes information about external factors that may cause deviations in lending decision outcomes;
based on the exception information, dividing lending decisions in the sibling batch into:
a first sibling batch that includes only non-exception outcomes; and
a second sibling batch that includes only exception outcomes;
determining whether the policy module exhibits the prohibited bias based on a degree of deviation among lending decisions in the first sibling batch; and
determining whether the policy module is rule compliant based on exception outcomes in the second sibling batch and corresponding rules in the exception information.

25. The one or more non-transitory computer-readable media of claim 14 further comprising instructions for:
reading exception information that includes information about external factors that may cause deviations in lending decision outcomes; and
based on the exception information, selecting for the second set of one or more input parameters, only values to which external factors do not apply.

26. The one or more non-transitory computer-readable media of claim 14 wherein the policy module is a first policy module and the sibling batch is a first sibling batch, the one or more non-transitory computer-readable media further comprising instructions for:
performing a second plurality of testing iterations, based on the single test case, to generate a second sibling batch of lending decisions using a second policy module that is different from the first policy module;
performing a comparison between lending decisions in the first sibling batch and lending decisions in the second sibling batch; and
generating a quality score for the first policy module based, at least in part, on the comparison.
